(19) United States
(12) Patent Application Publication
(10) Pub. No.: US 2017/0253508 A1
(43) Pub. Date: Sep. 7, 2017

(54) METHOD AND SYSTEM OF WASTEWATER TREATMENT HAVING A ZERO DISCHARGE OF SLUDGE

(71) Applicant: Jiangxi JDL Environmental Protection Co., Ltd., Nanchang (CN)

(72) Inventors: Zhimin LIAO, Nanchang (CN); Tao ZHOU, Nanchang (CN)

(21) Appl. No.: 15/600,785

(22) Filed: May 21, 2017

Related U.S. Application Data
(63) Continuation-in-part of application No. PCT/CN2015/091143, filed on Sep. 29, 2015.

(30) Foreign Application Priority Data
Sep. 1, 2015 (CN) 201510552129.8

(51) Int. Cl. C02F 3/12; C02F 3/34; C02F 3/00

(52) U.S. Cl. CPC C02F 3/1273; C02F 3/006; C02F 3/1205; C02F 3/12; C02F 3/34; C02F 1/444

(57) ABSTRACT

A method for wastewater treatment having a zero discharge of sludge, the method including: a) providing a membrane bioreactor system including a membrane separation system and a reaction vessel; and b) aerating the membrane separation system and the reaction vessel to control the dissolved oxygen concentration around the membrane separation system to be greater than 0 and smaller than 2 mg/L and the dissolved oxygen concentration in the reaction vessel excluding the membrane separation system to be greater than 0 and smaller than 1 mg/L. A wastewater treatment system having a zero discharge of sludge includes a membrane bioreactor system including: a reaction vessel, a membrane separation system, a water production system, and an aeration system.

### CROSS-REFERENCE TO RELATED APPLICATIONS

This application is a continuation-in-part of International Patent Application No. PCT/CN2015/091143 with an international filing date of Sep. 29, 2015, designating the United States, now pending, and further claims foreign priority benefits to Chinese Patent Application No. 201510552129.8 filed Sep. 1, 2015. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, Mass. 02142.

### BACKGROUND OF THE INVENTION

Field of the Invention

The invention relates to a method and a system of wastewater treatment having a zero discharge of sludge.

Description of the Related Art

A conventional method for removing silt from the wastewater is mainly dependent on the gravity of the silt. Although large particles are removed, small particles pass through. Small particles that pass through enter the reaction system and obstruct the filter system.

### SUMMARY OF THE INVENTION

In view of the above-described problems, it is one objective of the invention to provide a method and a system of wastewater treatment having a zero discharge of sludge.

To achieve the above objective, in accordance with one embodiment of the invention, there is provided a method for wastewater treatment having a zero discharge of sludge, the method comprising: a) providing a membrane bioreactor system comprising a membrane separation system and a reaction vessel; and b) aerating the membrane separation system and the reaction vessel to control a dissolved oxygen concentration around the membrane separation system to be greater than 0 and smaller than 2 mg/L and the dissolved oxygen concentration in the reaction vessel excluding the membrane separation system to be greater than 0 and smaller than 1 mg/L.

In a class of this embodiment, a microbial community comprising silicate bacteria is cultivated and acclimatized in the reaction vessel.

The present disclosure also provides a wastewater treatment system having a zero discharge of sludge, the system comprises: a pretreating system for preliminarily removing solid particles, and a membrane bioreactor system. The membrane bioreactor system comprises: a reaction vessel, a membrane separation system, a water production system, and an aeration system. The membrane separation system is disposed in the reaction vessel. The water production system communicates with the membrane separation system for pumping a filtrate out of the membrane separation system. The aeration system is adapted to aerate the reaction vessel and the membrane separation system. The aeration system is configured to control a dissolved oxygen concentration around the membrane separation system to be greater than 0 and smaller than 2 mg/L and the dissolved oxygen concentration in the reaction vessel excluding the membrane separation system to be greater than 0 and smaller than 1 mg/L.

In a class of this embodiment, the membrane separation system adopts a microfiltration membrane or an ultrafiltration membrane.

In a class of this embodiment, the aeration system adopts microporous aeration, perforated aeration, or a combination thereof.

In a class of this embodiment, the membrane separation system is concentratedly scoured by the aeration system.

In a class of this embodiment, the pretreating system is a grid for filtering the wastewater.

Compared with the prior art, advantages of the wastewater treatment method and the system of the present disclosure are summarized as follows: the method and the system of the invention are adapted to cultivate and acclimate the microbial community comprising the silicate bacteria that are able to remove multiple pollutants. The inorganic silt and organic sludge in the wastewater are gradually decomposed into gas and dissolvable substances in the process of the proliferation and metabolism of the microbes. A primary content of the inorganic silt is silica. As the silicate bacteria quickly grows and become predominant in the system in the reaction region, silica is converted into dissolvable silicate ions which are able to penetrate the membrane separation system and is carried away by the water thereby realizing the decomposition of the inorganic silt. The method and the system of the invention can be utilized by combining with other biochemical treatment processes.

### BRIEF DESCRIPTION OF THE DRAWINGS

FIG. 1 is a structure diagram of a wastewater treatment system having a zero discharge of sludge in accordance with one embodiment of the invention; and

FIG. 2 is a structure diagram illustrating aeration scouring of a wastewater treatment system in accordance with one embodiment of the invention.

### DETAILED DESCRIPTION OF THE EMBODIMENTS

For further illustrating the invention, experiments detailing a method and a system of wastewater treatment having a zero discharge of sludge are described hereinbelow combined with the drawings.

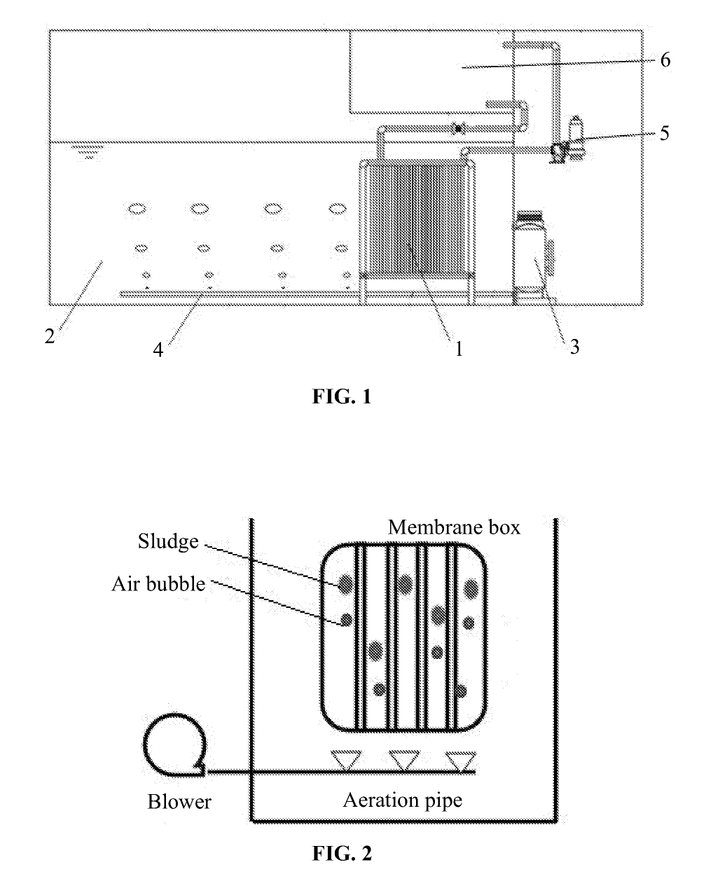

A wastewater treatment system having a zero discharge of sludge comprises: a pretreating system for preliminarily removing solid particles and a membrane bioreactor system. The pretreating system, not shown in the figures, adopts a wastewater treatment grid which is well known in the prior art or other pretreating systems. As shown in FIG. 1, the membrane bioreactor system comprises: a membrane separation system 1, a reaction pool 2, a blower 3, an aeration pipe 4, a water production pump 5, a clean water pool 6, and a pipeline. The membrane separation system 1 adopts a microfiltration membrane. The membrane separation system 1 is disposed in the reaction pool 2. The water production pump 5 communicates with the membrane separation system 1 via the pipeline for pumping a filtrate from the membrane separation system 1 to the clean water pool 6. The reaction pool 2 and the membrane separation system 1 are aerated by the blower 3 via the aeration pipe 4 so as to form a dissolved oxygen concentration gradient in the reaction pool 2 and meanwhile scour the membrane separation system 1 by aeration.

It can be understood that a microfiltration membrane or other membrane types well known in the prior art is employed by the membrane separation system 1. The reaction pool 2 optionally adopts reaction vessels in the prior art, such as a reaction tank. An aeration system is formed by the blower 3 and the aeration pipe 4, and the aeration system preferably adopts a combination of microporous aeration and perforated aeration. Also, the aeration system can adopt other aeration systems in the prior art. A water production system is formed by the water production pump 5 and the pipe, and the water production system can also adopt other water production system in the prior art, such as a gravity flow type water production system.

As intercepted by the pretreating system, solid particles of relatively large size are preliminarily removed, and inorganic silt including relatively small particles and wastewater are introduced to the membrane bioreactor system. The inorganic silt including the relatively small particles and the organic sludge in the wastewater are intercepted out of the membrane separation system 1 in the reaction pool 2. The reaction pool 2 adopts the combination of the microporous aeration and perforated aeration, and an aeration region is disposed in the vicinity of the membrane assembly. A dissolved oxygen concentration at the membrane assembly is controlled at 1-2 mg/L, and the dissolved oxygen concentration at other regions in the reaction pool is controlled at 0.5-1 mg/L.

A microbial community comprising silicate bacteria is cultivated and acclimatized in the reaction pool 2 in such aeration condition. The inorganic silt and organic sludge in the wastewater are gradually decomposed into gas and dissolvable substances in the process of the proliferation and metabolism of the microbes. A primary content of the inorganic silt is silica. As the silicate bacteria quickly grows and become predominant in the system in the reaction region, silica is converted into dissolvable silicate ions which are able to penetrate the membrane separation system and is carried away by the water thereby realizing the decomposition of the inorganic silt. It can be understood that the silicate bacteria can also be inoculated to the reaction pool 2.

The method for wastewater treatment having a zero discharge of sludge of the invention is able to fully decompose both the inorganic silt and the organic sludge, so that the zero-discharge of the sludge is realized in the true sense, and the effluent after the treatment meet the standard of reuse of urban recycling water-water quality standard for urban miscellaneous water consumption. The method of the invention can be utilized alone, such as in the conventional sewage treatment, or in a combination with other biochemical treatment process, such as in treatment of highly concentrated organic effluent. The wastewater treatment effect of the method of the invention is not affected when the sludge is artificially discharged.

The invention claimed is:

1. A method for wastewater treatment having a zero discharge of sludge, the method comprising:
a) providing a membrane bioreactor system comprising a membrane separation system and a reaction vessel; and
b) aerating the membrane separation system and the reaction vessel to control a dissolved oxygen concentration around the membrane separation system to be greater than 0 and smaller than 2 mg/L and the dissolved oxygen concentration in the reaction vessel excluding the membrane separation system to be greater than 0 and smaller than 1 mg/L.

2. The method of claim 1, wherein a microbial community comprising silicate bacteria is cultivated and acclimatized in the reaction vessel.

3. A wastewater treatment system having a zero discharge of sludge, the system comprising a pretreating system for preliminarily removing solid particles, wherein the system further comprises a membrane bioreactor system, and the membrane bioreactor system comprises: a reaction vessel, a membrane separation system, a water production system, and an aeration system; the membrane separation system is disposed in the reaction vessel; the water production system communicates with the membrane separation system for pumping a filtrate out of the membrane separation system; the aeration system is adapted to aerate the reaction vessel and the membrane separation system; and the aeration system is configured to control a dissolved oxygen concentration around the membrane separation system to be greater than 0 and smaller than 2 mg/L and the dissolved oxygen concentration in the reaction vessel excluding the membrane separation system to be greater than 0 and smaller than 1 mg/L.

4. The system of claim 3, wherein the membrane separation system adopts a microfiltration membrane or an ultrafiltration membrane.

5. The system of claim 3, wherein the aeration system adopts microporous aeration, perforated aeration, or a combination thereof.

6. The system of claim 5, wherein the membrane separation system is concentratedly scoured by the aeration system.

7. The system of claim 3, wherein the pretreating system is a grid for filtering the wastewater.
